(19) United States
(12) Patent Application Publication
(10) Pub. No.: US 2004/0204018 A1
(43) Pub. Date: Oct. 14, 2004

(54) Echo cellular phone

(75) Inventor: Horngyuh Kuo, Hsinchu (TW)

Correspondence Address: BACON & THOMAS, PLLC, 625 SLATERS LANE, FOURTH FLOOR, ALEXANDRIA, VA, 22314

(73) Assignee: LITE-ON TECHNOLOGY CORPORATION, Taipei (TW)

(21) Appl. No.: 10/396,438

(22) Filed: Mar. 26, 2003

(30) Foreign Application Priority Data
Dec. 18, 2002 (TW) 91220577

(51) Int. Cl. H04B 1/38

(52) U.S. Cl. 455/550.1; 455/575.1; 455/90.1

(57) ABSTRACT

An echo cellular phone, comprises a central processing unit (CPU), memory connected with the CPU, storing device, liquid crystalline display, keyboard, antenna, speaker, and microphone. The echo cellular phone further includes an echo discerning module connected with the CPU; an external sound sends to the echo discerning module through the speaker to identify the input sound, then the speaker emits a sound for attracting the user's attention. Thereby, it helps the user to find the cellular phone.

### FIELD OF THE INVENTION

The present invention relates to an echo cellular phone, in particularly, to an echo cellular phone providing with an echo discerning module for responding external voice.

### BACKGROUND OF THE INVENTION

The development of cellular phone has advanced for new features and new functions. People's depending on cellular phone is increasing. People often forget where the cellular phone is after answering the proceeding call. It needs to spend much time for looking for the cellular phone. It is more difficult and spends much time to find especially an extra-mini cellular phone. It is discouraging when people is hurry to leave home under the necessity of carrying a cellular phone. For modern people, if looking for cellular phone becomes simpler, it will be more convenient.

### SUMMARY OF THE INVENTION

In view of cellular phone bringing more convenient life other than trouble, the present inventor has conducted investigation for resolving the above-mentioned problems and thus completed the present invention.

The main object of the present invention is to provide an echo cellular phone. When a user forgets where the cellular phone is, the user can unlock the cellular phone by sound (for example whistle or clap hand). The cellular phone immediately response the user by a ring sound after it receives the user's sound signal. Thereby, the user can find out the cellular phone and the cellular phone becomes more humanity.

These objects and the other objects, features, and advantages will be apparent to those people skilled in the art from the following detailed description in connection with the drawings.

### BRIEF DESCRIPTION OF THE DRAWINGS

FIG. 1 is a block diagram showing a structure of the echo cellular phone of the present invention; and

FIG. 2 is a flow chart showing the procedures for looking for a cellular phone according to the echo cellular phone of the present invention.

### DETAILED DESCRIPTION OF THE INVENTION

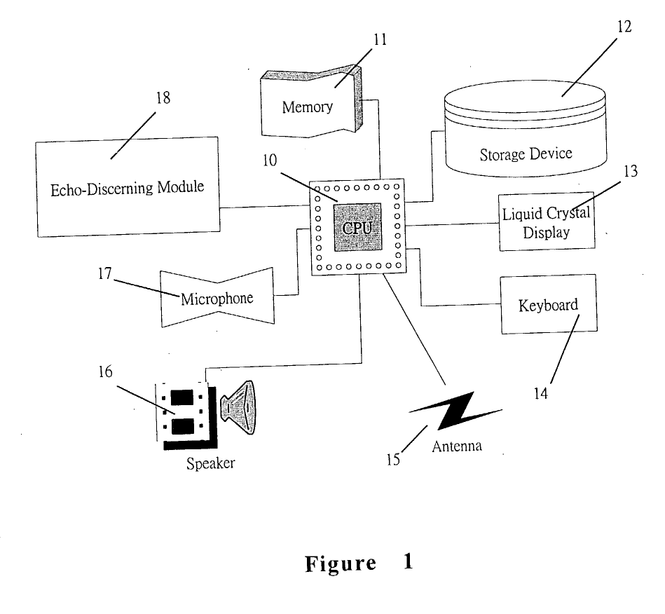

First of all, please refer to FIG. 1. FIG. 1 shows the structure of the echo cellular phone according to the present invention. From FIG. 1, an echo cellular phone 1 mainly comprises a central processing unit (CPU) 10, memory 11 connected with the CPU 10, storing device 12, liquid crystalline display 13, keyboard 14, antenna 15, speaker 16, and microphone 17. The above elements are necessary elements of common cellular phone and their functions are well known in this field. Thus the functions are not needed to explain here. The echo cellular phone according to the present invention further includes an echo discerning module for responding external voice in addition to the above elements. The echo-discerning module used in the present invention is not limited to a special module and can be any kind discerning integrated circuit. For example, it could use a discerning integrated circuit under item No. WD5102 produced by Wu-Chou Electron Company, China. When the cellular phone 1 is in idle mode, the echo discerning module 18 is started at the same time. If a user wants to look for the cellular phone, the user sends a sound signal, for example, claps hand or whistle, the sound signal is sent to the cellular phone through the speaker 17 and the echo discerning module 18 receives the sound signal, then the echo discerning module 18 instructs speaker 16 to emit a ring sound. At this time, the user could find the cellular phone by following the ring sound.

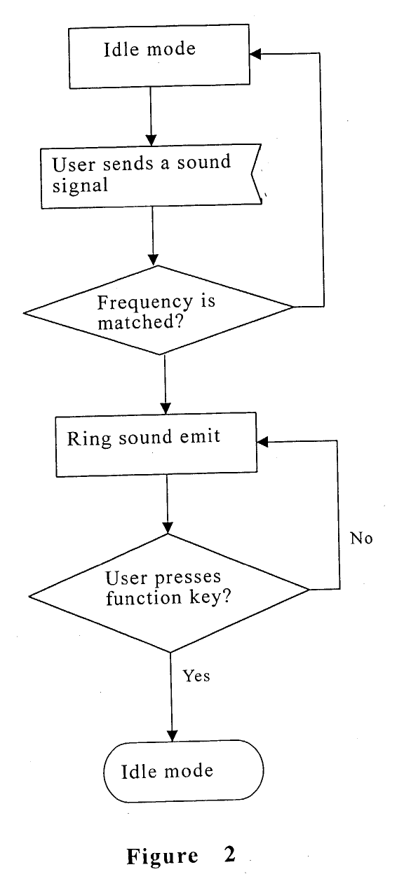

Next, please refer to FIG. 2. FIG. 2 is a flow chart showing the procedures for looking for a cellular phone according to the echo cellular phone of the present invention. First at all, the echo cellular phone to be found is in idle mode (step S21). The user sends a sound signal (such as clap hand or whistle) in the air (step S22). The echo discerning module 18 provided in the cellular phone receives the signal then input it to the CPU to identify whether the frequency of the sound (for example, the number of clapping or whistling per unit time) is matched (step S23). If the frequency is not matched, the cellular phone does not response and keep silent, the procedure is back to step S21 to wait for next instruction by the user. If the frequency is matched, the speaker of the cellular phone will emit a ring sound (step S24). After a certain time passing, the cellular phone will check whether the user presses a function key (step S25). If not, it means the user has not yet found the cellular, then the emitting of ring sound is continued. If the user presses a function key, it means the cellular phone has been found. Hereinafter, the cellular phone is back to be in idle mode.

Although the present invention has been described by the above embodiment, the present invention is not limited by the embodiment. Person skilled in the art would make various changes or modification without departing from the spirit and the scope of the present invention. The present invention is only limited by the appended claims.

What is claimed is:

1. An echo cellular phone, comprises a central processing unit (CPU), memory connected with the CPU, storing device, liquid crystalline display, keyboard, antenna, speaker, and microphone; which is characterized that the echo cellular phone further includes an echo discerning module connected with the CPU; an external sound sends to the echo discerning module through the speaker to identify the input sound, then the speaker emits a sound for attracting the user's attention.

2. The echo cellular phone according to claim 1, wherein the echo discerning module is also started when the cellular phone is turned on.

3. The echo cellular phone according to claim 1 or 2, wherein the external sound is a clapping sound or whistling come from the user.

4. The echo cellular phone according to claim 3, wherein the user claps hand twice or whistles once.
